(19) United States
(12) Patent Application Publication
(10) Pub. No.: US 2011/0048461 A1
(43) Pub. Date: Mar. 3, 2011

(54) TOOL FOR A STEAM CLEANING DEVICE AND METHOD OF CLEANING

(75) Inventor: Peter Teerlink, Rotterdam (NL)

(73) Assignee: INNOCLEANING MAGMA HOLDING B.V., Capelle Aan Den IJssel (NL)

(21) Appl. No.: 12/668,227

(22) PCT Filed: Jul. 9, 2007
(86) PCT No.: PCT/NL07/50337

§ 371 Date: Nov. 17, 2010

(51) Int. Cl. B08B 7/00

(52) U.S. Cl. 134/19; 15/320

(57) ABSTRACT

Tool for a steam cleaning device, provided with a steam element that is provided with nozzles, and a steam guide for guiding steam through said steam element to said nozzles, wherein said steam element is arranged to extend along different sides of an object for dispensing steam to said object. Method of cleaning at least a part of an object wherein steam is dispensed by a steam element that extends at least partly along at least two different sides of said object, and dispenses steam to said object.

The invention relates to a tool for a steam cleaning device.

The invention also relates to a method of cleaning at least a part of an object with the use of steam.

Conventionally, curtains are taken from the curtain rail before being cleaned in a washing machine, for example in private homes or hospitals. For saving time and/or costs some hospitals prefer to use disposable curtains. When using washing machines or disposable curtains, the costs for having clean curtains are relatively high.

Furthermore, methods are known wherein curtains can be cleaned with the use of steam, and without taking the curtain from its rail. Such a method is described in Japanese patent application publication JP2002210420, for example. In this method, a steam dispensing device is passed along one side of a hanging curtain such that steam is dispensed to that side of the curtain, allowing the curtain to be steam cleaned without having to take it from its rail.

Also other methods are known, wherein flat surfaces are steam cleaned with steam mops. However, the use of steam mops is usually meant for flat surfaces, e.g. floors, only.

The present invention has as a possible object to provide for a device or method with which a curtain or other object, for example a sheet or tube, can be cleaned in an alternative manner.

In a first aspect a tool for a steam cleaning device is provided, comprising a steam element that is provided with nozzles, and a steam guide for guiding steam through said steam element to said nozzles, wherein said steam element is arranged to extend along different sides of an object for dispensing steam to said object.

The tool according to the invention is configured to dispense steam to objects such as, but not limited to, curtains, or any kind of fabric or sheets, e.g. blankets, tubes, pipes, (door) handles, in general relatively thin or elongate shapes of which multiple sides are exposed to surrounding air and/or contamination such as bacteria. For example, the tool is fixedly connected to or integrated with a steam cleaning device, or functions as an exchangeable end piece to be exchanged with other tools. Also, a part of the tool, in particular the steam element, one or two arms, or a fluid absorbing surface, may function as an exchangeable element within the tool. The tool can for example be fixed to a steam cleaning device and/or a vacuum cleaner, in particular to a hose or pipe thereof. Preferably, the steam element comprises at least two arms.

In a second aspect a method of cleaning at least a part of an object is provided, wherein steam is dispensed by at least one arm that extends at least partly along at least two different sides of said object, and dispenses steam to said object.

For a better understanding of the present invention, exemplary embodiments thereof will be discussed hereafter with reference to the drawing, in which:

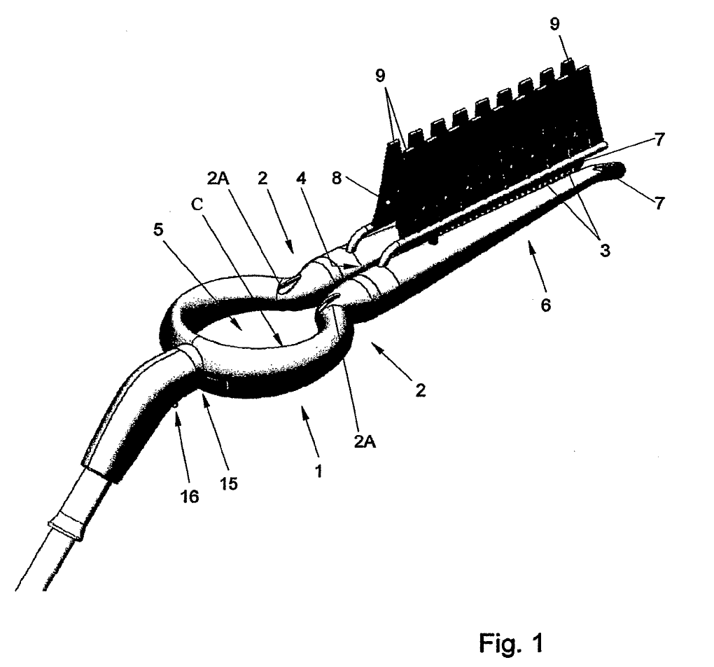

FIG. 1 shows a perspective view of a tool for a steam cleaning device;

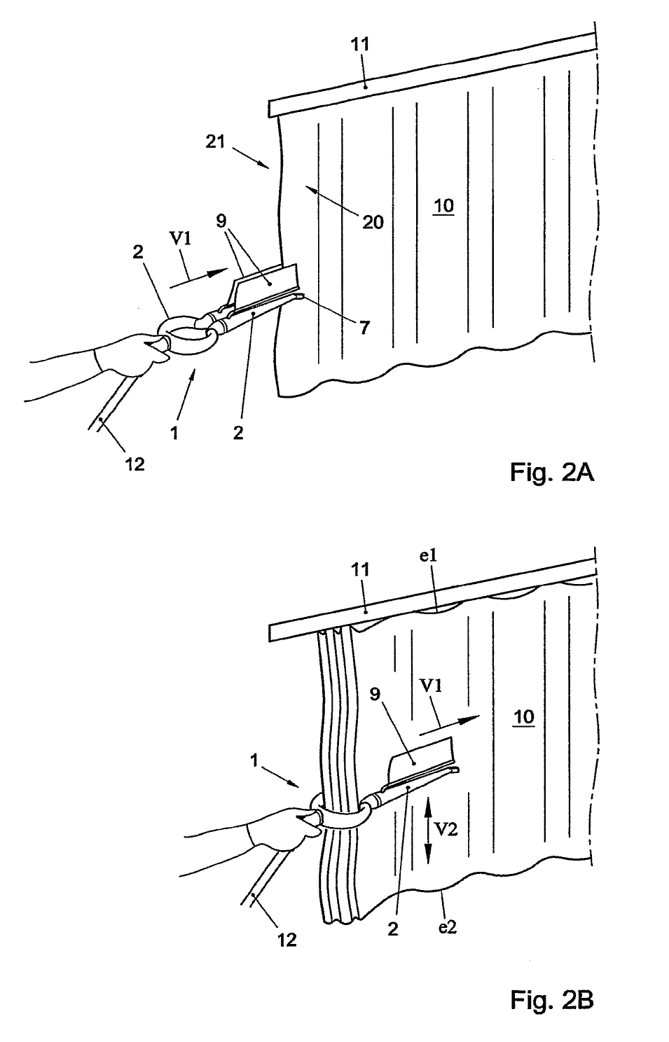

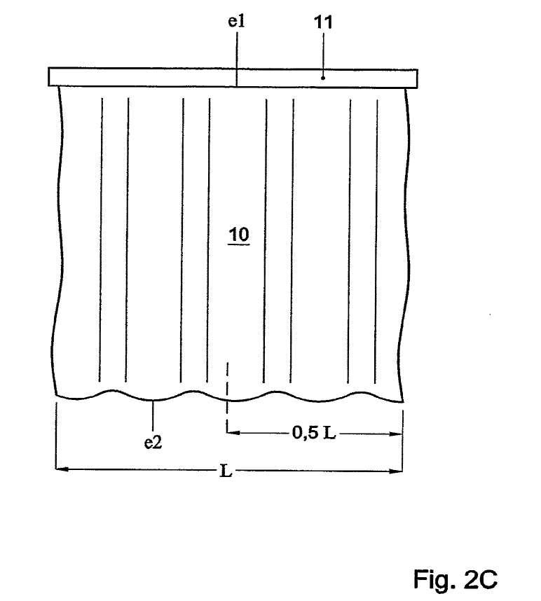

FIGS. 2A and 2B show a perspective view of a use of a tool for a steam cleaning device;

FIG. 2C shows a front view of a curtain;

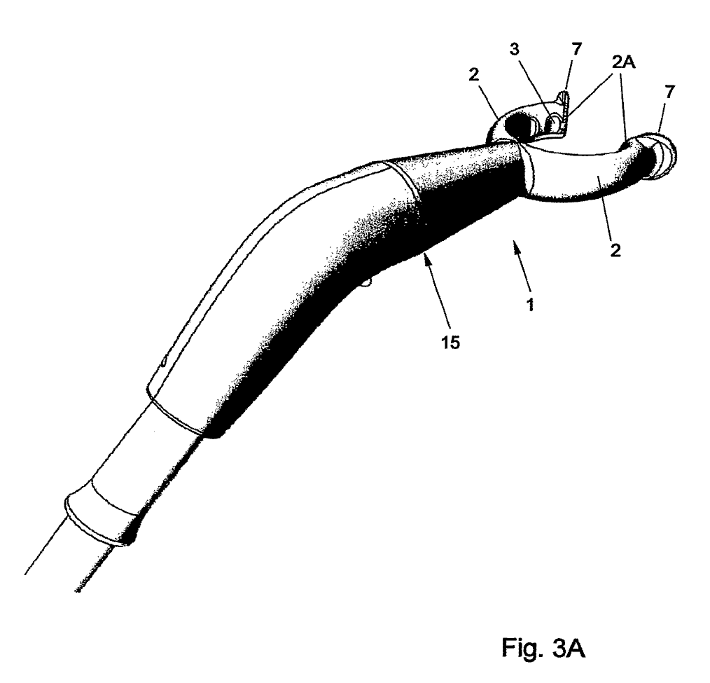

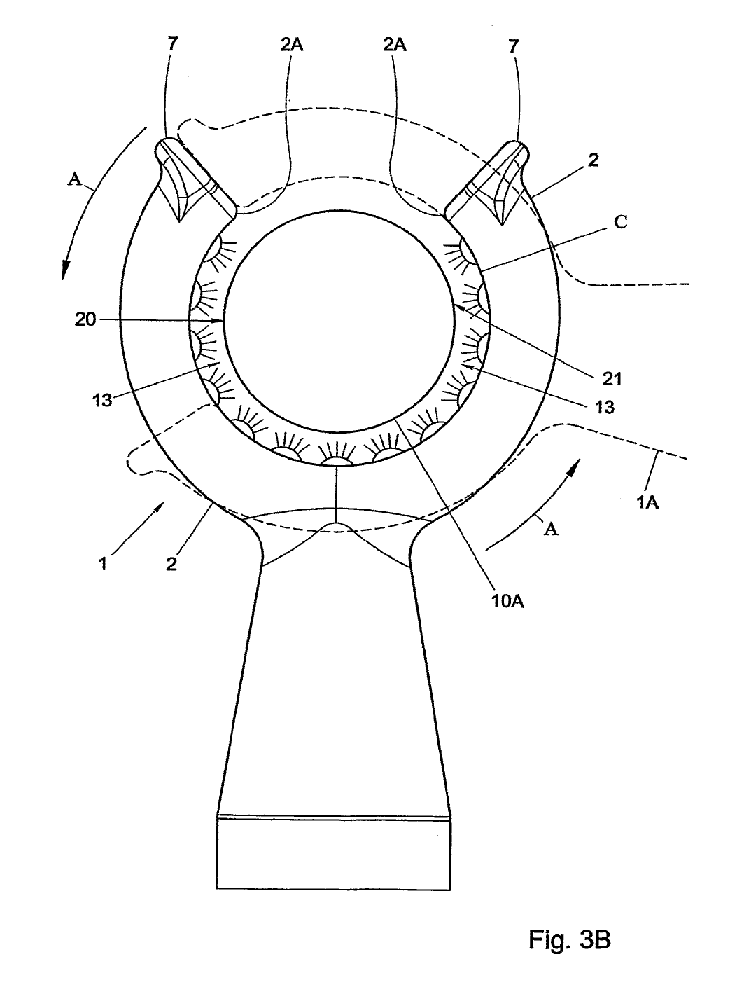

FIG. 3A shows a perspective view of a tool for a steam cleaning device;

FIG. 3B shows a top view of a tool for a steam cleaning device;

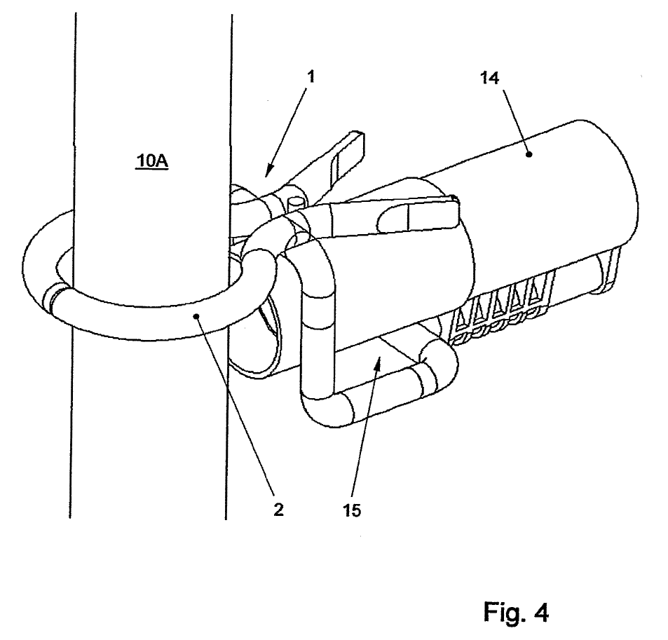

FIG. 4 shows a perspective view of a tool for a steam cleaning device;

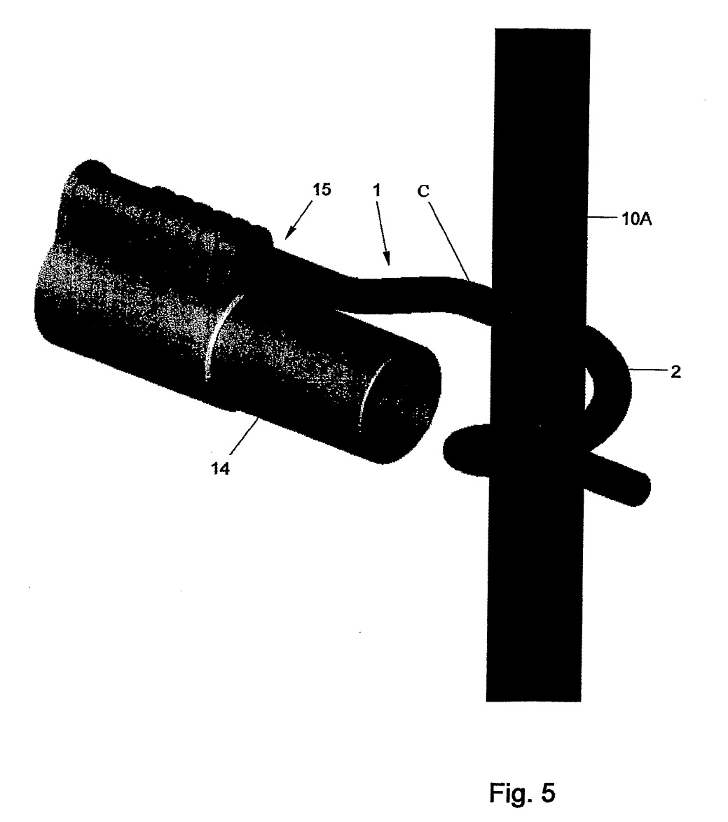

FIG. 5 shows a perspective view of a tool for a steam cleaning device.

In the figures, only exemplary embodiments of the invention are shown, by way of illustration. These should not in any way be construed as limiting. Many variations thereon are possible within the framework of the invention outlined by the claims. In this description, the same or corresponding parts have the same or corresponding reference numerals.

FIG. 1 shows a tool 1 for a steam cleaning device, provided with a steam element that comprises two arms 2 that are provided with nozzles 3. Within the arms 2 steam guides are provided to guide steam to the nozzles 3. Preferably, the two arms 2 are arranged to extend along different sides 20, 21 of a curtain 10, for dispensing steam to that curtain 10.

In an embodiment, the nozzles 3 are arranged to dispense steam to opposite sides 20, 21 of the curtain 10. Preferably the nozzles 3 are arranged in each arm 2, facing towards each other in opposite directions, such that steam is dispensed in opposite directions towards both sides 20, 21 of the curtain 10. Between the arms 2 a space may be defined that comprises a narrow section 4 and a wide section 5. In the embodiment of FIG. 1, the wide section 5 is located near the handle and the narrow section 4 is located near the end. At the narrow section 4 the arms 2 are substantially parallel and at the end 6 the tool is 1 provided with receiving elements 7 for guiding a part of the curtain 10 that is to be cleaned between said two arms 2. In use, the parallel arms 2 extend along both sides of the curtain 10 and the tool 1 is moved along the curtain 10 while steam is dispensed to the curtain 10 from a close distance. The tool 1 may be provided with a connection element 15 for connection to a steam generator and/or actuating mechanism 16.

In an advantageous embodiment the tool 1 is provided with a fluid absorbing surface 8. For optimal absorbance of fluids, dirt, dust, grease, and more particularly bacteria's, the fluid absorbing surface 8 comprises microfibers. In the embodiment shown in FIG. 1 the arms 2 are provided with two sheets 9 made of or provided with said fluid absorbing surface 8.

A possible use of a tool 1 is shown in FIGS. 2A and B. The tool 1 is held in the hand of a user and is already connected to a steam dispensing device, for example via a pipe or hose 12. The tool 1 is passed in a direction V1 towards the curtain 10, so that the curtain 10 is conveniently guided between the arms 2 of the tool 1, with the help of the receiving elements 7. Advantageously, the curtain 10 can be passed between both arms 2 while it is hanging from its curtain rail 11. Between the arms 2 the curtain 10 extends near the nozzles 3, so that steam can be dispensed close to the curtain 10. For example the distance between the arms 2, at least near the narrow section 4, may be several mm or cm.

When at least a part of the curtain 10 extends near the nozzles 3, the tool 1 can be moved along the surface of the curtain in a direction of travel V2, for example in a direction upwards and/or downwards (see FIG. 2B). Preferably, in use the sheets 9 are provided behind the nozzles 3, at least in the direction of travel V2.

When the curtain 10 is passed through the tool 1, the space between the arms 2 near the wide section 5 enables the curtain 10 to accumulate at the wide section 5, so that the curtain 10 can be passed further through the narrow section 4 tool 1 (see FIG. 2B). For example, at least a full length or width L or half a full length or width 0,5L of a curtain 10 can be passed through the tool 1 (see FIG. 2C), depending on the size of the curtain 10 and/or the shape of the tool 1. This enables the full length or width L of the curtain to be cleaned in steps. E.g. the tool 1 is passed along the curtain 10 in a direction of travel V2 while dispensing steam, from a first edge e1 to an opposite second edge e2 of the curtain 10. Then the tool 1 is passed along the curtain 10 in the direction towards the curtain V1, or pulled back from the curtain 10 in the opposite direction, and again moved between said first and second edge e1, e2 along the curtain 10 while dispensing steam.

The wide section 5 can be arranged to substantially enclose the accumulated curtain 10. Near the transition from the wide section 5 into the narrow section 4 the arms 2 may have at least one retaining section 2A, for example round and/or hook shaped, for retaining the accumulated curtain 10. Preferably the arms 2, including the retaining sections 2A, have an inner circumference C of at least approximately 180°, preferably at least approximately 270°, at least near the wide section 5.

When operating the tool 1, steam is dispensed to the curtain 10 by the arm 2 extending along two the two opposite sides 20, 21 the curtain 10. Preferably, the steam is dispensed in the direction of both opposite sides 20, 21 of the curtain 10. While dispensing steam, absorbing material 8, preferably microfiber material that is preferably arranged in the sheets 9, is passed along the curtain 10 for absorbing dispensed fluid, dust and/or debris, and particularly bacteria's. The sheets 9 may provide for a cleaning as well as a fluid absorbing function.

Another embodiment of a tool 1 is shown in FIGS. 3A and 3B. This tool 1 is configured to extend along different, e.g. opposite, sides 20, 21 of tube-shaped objects 10A or the like, for example the tubes 10A of a hospital bed. Preferably, an embodiment of a steam cleaning tool 1 is arranged such that steam 13 is dispensed to a tube 10A while the tube 10A is at least partly surrounded by the steam element that comprises one or more arms 2 and/or steam 13 is dispensed to the tube 10A about at least approximately 180°, preferably at least approximately 270°, or even up to approximately 360° of the periphery of the tube 10A. As shown in FIGS. 3A and 3B, the steam element may comprise two arms 2 that have an inner circumference C of at least approximately 180°, preferably at least approximately 270°.

In use, the tube cleaning tool 1 is brought into position by passing the receiving elements 7 over the tube 10A, such that the arms 2 substantially enclose the tube 10A. The receiving elements 7 may aid in guiding the tube 10A between the arms 2 and passed the retaining sections 2A. For example, the arms 2 may be at least partly flexible, to be able to press a relatively large tube 10A between the arms 2.

When the tube 10A extends between the arms 2, the tool 1 is passed along the tube 10A so that it is steam cleaned. When the steam 13 that is dispensed doesn't cover the circumference of the tube 10A, the tool 1 can be pivoted around the tube 10A in a direction A such that the steam 13 can reach the full circumference of the tube 10A, as is indicated by pivoted tool 1A in dashed lines in FIG. 3B. In use, the tool 1 is for example moved along the tube 10A over a certain distance, then pivoted, and then moved back along the tube 10A over said distance so that substantially the full outer surface of the tube 10A, at least over said distance, is cleaned.

In addition to, or instead of, a fluid absorbing surface 8, any fluid, dirt and/or bacteries that are adhered to a surface of an object can be sucked off the object with the use of a suction nozzle, for example. In such an embodiment, for example at least one of the nozzles 3 of the tool 1 is connectable to a vacuum suction device, or the steam dispensing tool 1 is connected to and/or integrated with a vacuum suction nozzle or hose 14, for example from a conventional vacuum cleaner. An exemplary embodiment of a tool 1 with an additional sucking function is arranged such that steam is dispensed at least one side 20 of an object and fluid, dirt and/or bacteria's are sucked at least another side 21 of said object. For example, a sucking and a steam dispensing nozzle 3 are arranged approximately facing towards each other. In such an embodiment fluid and/or dirt is actively sucked from at least one side of said object and simultaneously steam is dispensed at one or more sides to said object.

FIGS. 4 and 5 show alternative embodiments of a tool 1, wherein the steam element of FIG. 4 has two arms 2 and that of FIG. 5 has one arm 2. FIG. 4 shows a tool 1 wherein the arms 2, or at least parts thereof, can be moved with respect to each other in order to redefine the space enclosed by said arms 2. This allows the arms 2 to be opened and closed around a tube 10A, like jaws, so that the tube 10A can be enclosed around the periphery of the tube 10A or at least a large part thereof by this alternative tool 1. Nozzles 3 may be provided throughout the arms 2 such that steam is dispensed about the periphery of the tube 10A. As can be seen from FIG. 4, the tool 1 comprises a connection element 15 in order to connect to a steam generator and/or a suction device 14, for example.

The embodiment of FIG. 5 shows a tool 1 comprising one arm 2, which one arm 2 may surround a tube 10A at least partly, wherein the arm 2 is for example at least partly flexible to allow the arm 2 to be hooked around the tube 10A and enclose the tube 10A at least partly. Advantageously, nozzles 3 are provided at the inner circumference C of the arm 2 to dispense steam about at least a large part of the periphery of the tube 10A. Also this tool 1 may comprises a connection element 15 in order to connect to a steam generator and/or a suction device 14, for example.

The steam element and/or the arms 2 of the tool 1 can for example be configured to be exchangeable within the tool 1. For example in accordance with different contours and different cross sections between different products to be cleaned it may be advantageous to replace the steam element or at least one arm 2, instead of the tool 1, although in other cases it may be advantageous to replace the entire tool, and in again other cases another steam cleaning device is used. Also a part of an arm 2, for example the distal part 6A of at least one arm 2, can be replaced. Replacing or disconnecting and cleaning at least a part of an arm 2 can be advantageous to prevent the tool 1, or at least the arm 2, from being too contaminated after having used it for a while, for example. Also, the fluid absorbing surface 8 and/or the sheets 9 can be configured to be exchangeable such that they may be replaced and/or disposed after usage, for example, again to prevent a certain degree of contamination.

Tests have shown that the tool 1 is effective in removing bacteria's from objects. By dispensing steam close to the area that is to be cleaned the objects are cleaned more effectively. The shape of different embodiments of the tool 1 enables the substantial enclosing of objects, and dispensing of steam at a close distance to said objects. Moreover, the application of a fluid absorbing surface 8 allows for quick absorbance of the dispensed fluids and/or bacteria's. Preferably such surfaces 8 comprise microfibers, which were tested to be suitable.

Next to curtains 10 or tubes 10A embodiments of the invention can be used advantageously to clean for example any sheet-like material, for example synthetic or natural fabrics, Venetian blinds, etc. or tubes of any shape, i.e. round as well as cornered tubes, pipes, door handles, etc. An advantageous application of the invention concerns hospitals, e.g. as an additional tool and/or method for decontamination and/or sterilisation of objects, furnitures, in particular tubes and curtains, in hospitals. The invention enables decontamination of certain surfaces in a hospital room in an efficient way.

It shall be obvious that the invention is not limited in any way to the embodiments that are represented in the description and the drawings. Many variations and combinations are possible within the framework of the invention as outlined by the claims. The aspects and elements derivable from the description or at least falling within the framework of the invention can be taken separately and combined with other aspects or elements of any embodiment of the invention. Combinations of one or more aspects of the embodiments or combinations of different embodiments are possible within the framework of the invention. All comparable variations are understood to fall within the framework of the invention as outlined by the claims.

1. Tool for a steam cleaning device, provided with a steam element that is provided with nozzles, and a steam guide for guiding steam through said steam element to said nozzles,
wherein said steam element is arranged to extend along different sides of an object for dispensing steam to said object.

2. Tool according to claim 1, wherein the steam guide and nozzles are arranged to dispense steam to different sides of an object.

3. Tool according claim 1, wherein the tool is provided with a fluid absorbing surface, preferably comprising microfibers.

4. Tool according to claim 3, wherein the tool is provided with at least one sheet having said fluid absorbing surface.

5. Tool according to claim 1, wherein the nozzles are arranged facing towards each other.

6. Tool according to claim 1, wherein the steam element has an inner circumference that encloses a space, which space comprises a narrow section and a wide section.

7. Tool according to claim 6, wherein said steam element comprises at least two arms, wherein at least one of said arms is provided with nozzles, and a space is defined between said arms.

8. Tool according to claim 7, wherein at least parts of said arms can be moved with respect to each other in order to redefine the space enclosed by said arms.

9. Tool according to claim 7, wherein at least a part of said arms are substantially parallel, at least towards an end of the tool.

10. Tool according to claim 7, wherein the steam element has an inner circumference of at least approximately 180°, preferably at least approximately 270°.

11. Tool according to claim 8, wherein the tool is provided with receiving elements for guiding a part of an object that is to be cleaned within said steam element.

12. Tool according to claim 8, wherein the tool comprises a connection element in order to connect to a steam generator.

13. Exchangeable arm for use in a tool according to claim 8.

14. Steam cleaning device with a tool according to claim 13.

15. Method of cleaning at least a part of an object wherein steam is dispensed by a steam element that extends at least partly along at least two different sides of said object, and dispenses steam to said object.

16. Method according to claim 15, wherein while dispensing steam to said object, fluid absorbing material, preferably microfiber material, is passed along said object.

17. Method according to claim 15, wherein steam is dispensed to two different sides of said object.

18. Method according to claim 15, wherein steam is dispensed to said object while the object is at least partly surrounded by said steam element and steam is dispensed about at least approximately 180°, preferably at least around 270° of the periphery of the object.

19. Method according to claim 15, wherein said at least one object comprises a sheet, such as a curtain, or a tube.
